(19) United States
(12) Patent Application Publication
(10) Pub. No.: US 2012/0287930 A1
(43) Pub. Date: Nov. 15, 2012

(54) Local switching at a fabric extender

(75) Inventor: Pirabhu Raman, San Jose, CA (US)

(73) Assignee: CISCO TECHNOLOGY, INC., San Jose, CA (US)

(21) Appl. No.: 13/068,540

(22) Filed: May 13, 2011

(51) Int. Cl. H04L 12/56

(52) U.S. Cl. 370/392

(57) ABSTRACT

In one embodiment, a method includes receiving a packet at a fabric extender, performing a look up in a flow table at the fabric extender for a flow associated with the packet, processing the packet at the fabric extender based on an entry in the flow table if an entry for the flow is found in the flow table, and forwarding the packet to an upstream network device configured to forward the packet if an entry for the flow is not found in the flow table. An apparatus is also disclosed.

### TECHNICAL FIELD

The present disclosure relates generally to communication networks, and more particularly, to fabric extenders.

### BACKGROUND

Fabric extenders (FEXs) are used to simplify network access architecture and operations. A fabric extender may operate, for example, as a remote line card for a switch. The architecture enables physical topologies with the flexibility and benefits of top-of-rack (ToR) and end-of-row (EoR) deployments.

### BRIEF DESCRIPTION OF THE FIGURES

FIG. 1 illustrates an example of a network in which embodiments described herein may be implemented.

FIG. 2 is a block diagram illustrating an example of a network device useful in implementing embodiments described herein.

FIG. 3 is an example of a flow table installed at a fabric extender in the network of FIG. 1.

FIG. 4 is a flowchart illustrating a process for performing local switching at the fabric extender, in accordance with one embodiment.

FIG. 5 is a flowchart illustrating a process for updating the flow table at the fabric extender, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving a packet at a fabric extender, performing a look up in a flow table at the fabric extender for a flow associated with the packet, processing the packet at the fabric extender based on an entry in the flow table if an entry for the flow is found in the flow table, and forwarding the packet to an upstream network device configured to forward the packet if an entry for the flow is not found in the flow table.

In another embodiment, an apparatus generally comprises a plurality of interfaces for communication with one or more upstream network devices configured for forwarding packets and communication with one or more downstream nodes, and a processor for performing a look up in a flow table at a fabric extender for a flow associated with a packet received at one of said interfaces in communication with the downstream node, processing the packet based on an entry in the flow table if an entry for the flow is found in the flow table, and forwarding the packet to the upstream network device if an entry for the flow is not found in the flow table. The apparatus further comprises memory for storing the flow table.

### Example Embodiments

The following description is presented to enable one of ordinary skill in the art to make and use the embodiments. Descriptions of specific embodiments and applications are provided only as examples and various modifications will be readily apparent to those skilled in the art. The general principles described herein may be applied to other embodiments and applications without departing from the scope of the embodiments. Thus, the embodiments are not to be limited to those shown, but are to be accorded the widest scope consistent with the principles and features described herein. For purpose of clarity, features relating to technical material that is known in the technical fields related to the embodiments have not been described in detail.

The embodiments described herein provide local switching at a fabric extender (FEX) architecture to generally improve network performance and reduce management points within the network. As described below, the embodiments operate in the context of a data communications network including multiple network elements.

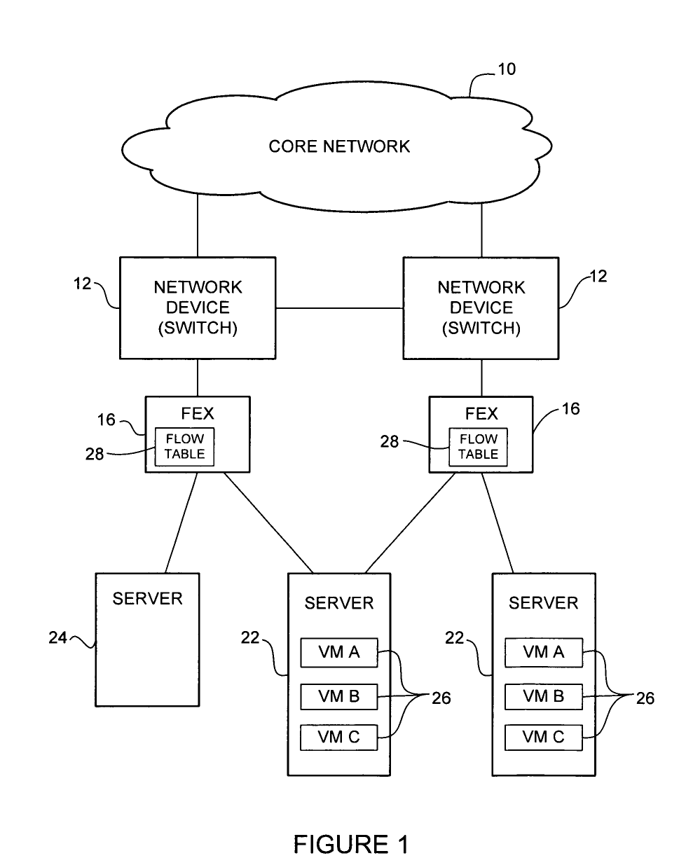

Referring now to the figures, and first to FIG. 1, an example of a network that may implement embodiments described herein is shown. The network may be configured for use as a data center, campus network, or any other type of network. The network shown in FIG. 1 includes network devices 12 in communication with a core network 10 (e.g., aggregation network, Layer 2 (L2)/Layer 3 (L3) boundary). The network devices 12 may be switches, routers, or other network devices configured to perform forwarding functions. The network device 12 may include one or more forwarding table, routing table, forwarding information base, or routing information base used in performing switching or routing functions. The network device 12 may be, for example, a NEXUS 5000 or NEXUS 7000 switch available from Cisco Systems, Inc. of San Jose, Calif. In one example, the network devices 12 are access layer switches (e.g. NEXUS 5000) and are in communication with one or more aggregation layer switches (e.g., NEXUS 7000) (not shown).

The switches 12 are each connected to an FEX (Fabric Extender) 16 (also referred to as a remote replicator, remote line card, or port extender). The FEX 16 is configured to operate as a remote line card for one or more switches 12 or other network devices. As described in detail below, the FEX 16 includes a flow table 28 for use in locally forwarding packets received from servers 22, 24. Local forwarding at the FEX 16 allows packets to be transmitted between servers or virtual machines in communication with the same FEX without transmitting the packets upstream to the switch 12.

Each FEX 16 is in communication with one or more servers 22, 24. It is to be understood that the term ‘server’ as used herein may refer to a conventional server, a server comprising virtual machines 26, or a host. Multiple ports at the server may be grouped as a virtual Port Channel (vPC). The server 22 may include a virtual switch (e.g., virtual Ethernet module (VEM) of a Nexus 1000 switch, available from Cisco Systems, Inc.). In the example shown in FIG. 1, servers 22 each comprise a plurality of virtual machines (VM A, VM B, VM C) 26. Each virtual machine 26 includes a virtual interface. The virtual machines 26 share hardware resources without interfering with each other, thus enabling multiple operating systems and applications to execute at the same time on a single computer. A virtual machine monitor (not shown) may be used to dynamically allocate hardware resources to the virtual machines 26.

In the example shown in FIG. 1, the switches 12 are referred to as upstream network devices and the servers 22, 24 and virtual machines 26 are referred to as downstream nodes. The terms upstream and downstream as used herein refer to the location of the network device or node relative to the FEX. Packets may flow in both directions between the FEX 16 and the switch 12 and the FEX and servers 22, 24.

It is to be understood that the network shown in FIG. 1 is only one example, and that the embodiments described herein may be implemented in networks having different topologies and types of network devices. For example, the FEXs 16 may be in communication with any number of servers 22, 24 having any number of virtual machines (e.g., zero or more). Each FEX 16 may also be in communication with both switches 12. Also, there may be additional downstream switches in communication with one or more servers.

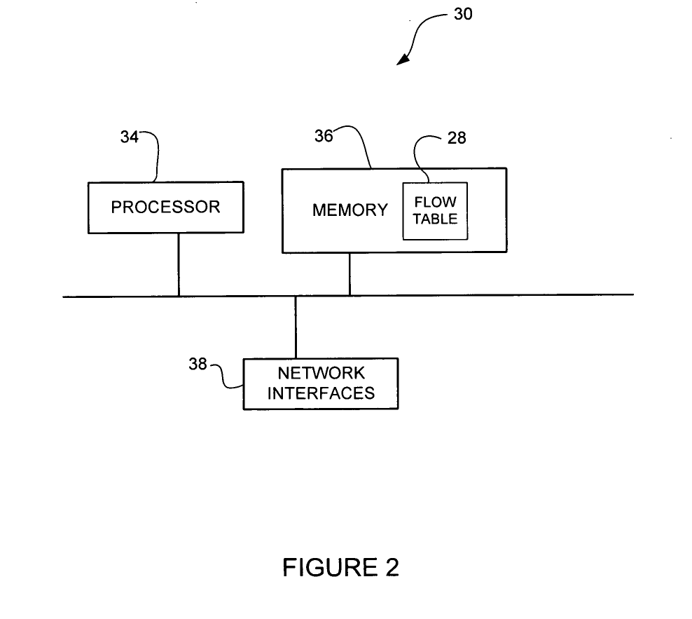

An example of a network device 30 that may be used to implement embodiments described herein is shown in FIG. 2. The network device 30 may operate as a fabric extender 16 in the network of FIG. 1, for example. In one embodiment, the network device 30 is a programmable machine that may be implemented in hardware, software, or any combination thereof. The network device 30 includes one or more processors 34, memory 36, and network interfaces 38.

Memory 36 may be a volatile memory or non-volatile storage, which stores various applications, modules, and data for execution and use by the processor 34.

Memory 36 may include flow table 28 (described below).

Logic may be encoded in one or more tangible media for execution by the processor 34. For example, the processor 34 may execute codes stored in a computer-readable medium such as memory 36. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interfaces 38 may comprise wired or wireless interfaces (line cards, ports) for receiving signals or data or transmitting signals or data to other devices. The network interfaces 38 may incorporate Ethernet interfaces, Gigabit Ethernet interfaces, 10-Gigabit Ethernet interfaces, SONET interfaces, etc.

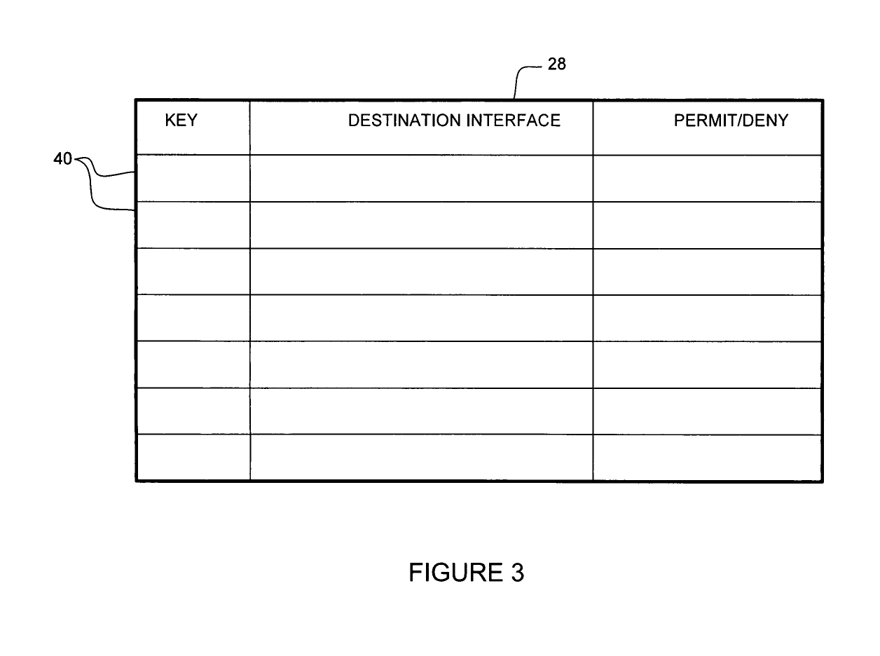

FIG. 3 illustrates an example of flow table 28 maintained by the FEX 16. In the example shown in FIG. 3, the table 28 includes three columns: key; destination interface; and permit/deny. The key is used to identify an entry 40 in the flow table 28 and is formed by key fields in the packet (e.g., (source, destination, MAC (media access control) address, VLAN (virtual local area network)), (source, destination IP address, port number for routed packet), or any other identifiers). The destination interface identifies a virtual interface or physical interface (e.g., port). The permit/deny column indicates whether a packet should be forwarded or dropped. As described below, the flow table 28 is preferably generally transparent to the upstream switch 12 and policies are applied by the upstream switch for consistency and reduced management. Flow table entries 40 are preferably aged periodically. For example, an entry may be aged if a specified numbers of continuous probe result packets (described below) are not received.

It is to be understood that the table 28 shown in FIG. 3 is only an example and other data structures containing additional or different data fields may be used, without departing from the scope of the embodiments.

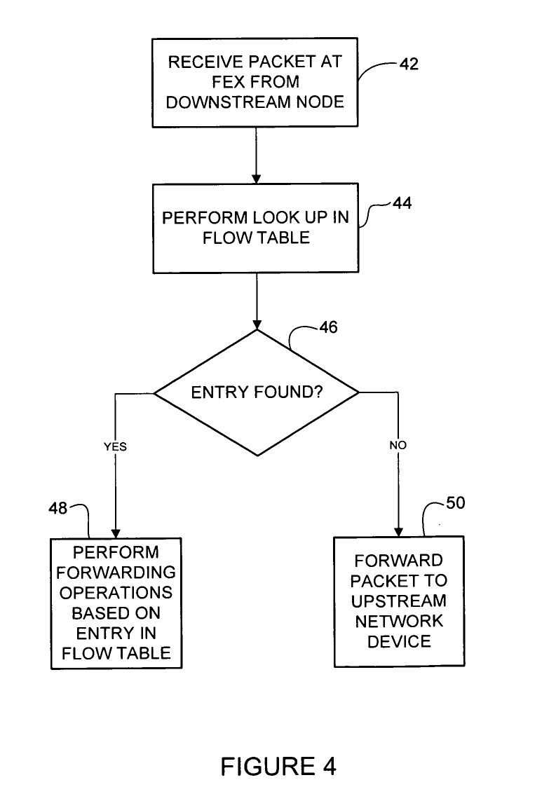

FIG. 4 is a flowchart illustrating a process for local switching at the FEX 16, in accordance with one embodiment. At step 42, the FEX 16 receives a packet from a downstream node (e.g., server 22, 24, virtual machine 26). The FEX 16 performs a look up in the flow table 28 for a flow associated with the packet using one or more identifiers from key fields in the packet (step 44). If an entry for the flow is found (i.e., hit in the flow table 28), the FEX 16 processes the packet (performs forwarding operations) based on the entry in the flow table (steps 46 and 48). For example, if the permit flag is set, the FEX 16 forwards the packet based on the destination interface identified in the flow table (i.e., FEX locally forwards the packet). If the deny flag is set, the FEX 16 drops the packet. This allows the FEX 16 to drop the packet at the earliest point so that there is no need to use upstream bandwidth. If no entry is found for the flow (i.e., miss in flow table 28), the packet is forwarded to one of the upstream network devices (e.g., switch 12) configured for forwarding the packet (steps 46 and 50). When the switch 12 receives the packet from the FEX 16, the switch performs forwarding operations and if needed, sends the packet to one of the FEXs 16.

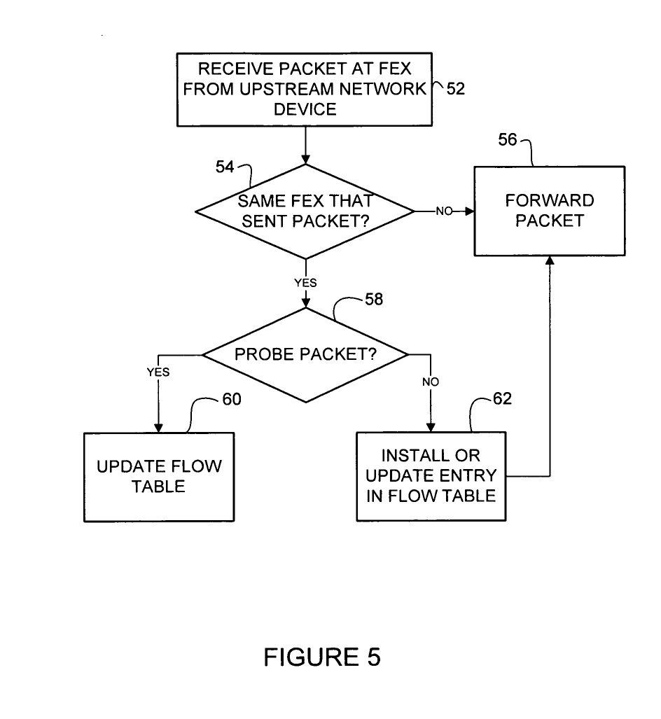

FIG. 5 is a flowchart illustrating a process performed at the FEX 16 upon receiving a packet from the upstream network devices 12, in accordance with one embodiment. At step 52 the FEX 16 receives a packet from one of the upstream switches 12. If the packet is not received at the same FEX 16 that sent the packet to the upstream switch 12, an entry is not needed in the flow table 28 and the FEX forwards the packet to one of the downstream nodes as indicated by the switch (steps 54 and 56). If the packet is returned to the same FEX 16 that transmitted the packet to the upstream switch 12 and the packet is a probe packet (described below) (steps 54 and 58), the probe packet is used to update the flow table 28 as required (e.g., install entry, update entry) (step 60). If the packet is not a probe packet, an entry is installed or updated in the flow table 28 as required, and the packet is forwarded (steps 62 and 56).

It is to be understood that the processes described above and shown in FIGS. 4 and 5 are only examples and that steps may be added, removed, combined, or reordered, without departing from the scope of the embodiments.

When a new entry is installed in the flow table 28, one or more follow on packets may already be enroute to the upstream switch 12. Therefore, if the new entry is activated immediately, out-of-order packet issues may arise. To avoid out-of-order issues, a timed buffer or drop approach may be used, for example. In the buffer approach, whenever a new entry is installed, subsequent packets are buffered for a specified timeframe (e.g., long enough to drain packets enroute to the upstream switch 12). At the end of this time period, local forwarding is enabled for the entry. In the drop approach, packets are dropped for the specified timeframe.

Policies are preferably applied at the upstream switch 12. Therefore, the FEX 16 should be in sync with policy changes made at the upstream switch 12. In one embodiment, probe packets are used to enforce upstream switch policy changes at the FEX 16. The FEX 16 may forward one out of a specified number of packets (e.g., one out of every few thousand packets) to the upstream switch 12. This forwarded packet is referred to herein as a probe packet. The probe packet undergoes normal forwarding lookups at the switch 12 and reflects any policy changes at the switch to the FEX 16. For example, if the probe packet is a permit packet, bits in the packet are set to indicate (probe result, permit). If the probe packet is a deny packet, action is taken based on the type of deny. For example, if it is a deny due to policies, bits are set in the packet to indicate (probe result, deny) and the packet is sent back to the FEX 16. In cases where the result cannot be relayed to the FEX 16, the FEX continues to send packets to the switch 12, where the packets will be dropped.

In another embodiment, local switching is turned off for specific flows or a flush mechanism is used for the flow table 28 so that packets are forwarded to the upstream switch and the table can be updated.

In one embodiment, a probe result bit is set in a VNTag (Virtual Network Tag) in the probe packet. VNTag is an example of a networking data frame header that can be used in a virtual network environment. In one example, two bits are used in the VNTag for the probe bits as follows:
00—Non-probe packets
01—Probe
10—Probe result, permit
11—Probe result, deny

In one embodiment, the switch 12 may be disabled at a per-flow granularity. The switch 12 controls the flow table population via the probe result packet. For example, a user may issue configurations on the switch 12 to turn off local switching for specific flows, which will in turn cause the switch to not set probe result bits in the VNTag.

For routed flows, the flow table 28 matches source/destination IP addresses. The fact that a packet is routed can be explicitly hinted by the switch 12 to FEX 16 or the FEX can cache a gateway MAC address of the upstream router.

In one embodiment, routed multi-destination flows are handled by performing replication on the switch/router, if egress policies are an issue. If egress policies are not an issue, the embodiments described herein may be used for routed multi-destination flows and the probe result packet can indicate multi-destinations rather than one destination.

Although the method and apparatus have been described in accordance with the embodiments shown, one of ordinary skill in the art will readily recognize that there could be variations made to the embodiments without departing from the scope of the embodiments. Accordingly, it is intended that all matter contained in the above description and shown in the accompanying drawings shall be interpreted as illustrative and not in a limiting sense.

What is claimed is:

1. A method comprising:
receiving a packet at a fabric extender;
performing a look up in a flow table at the fabric extender for a flow associated with the packet;
processing the packet at the fabric extender based on an entry in the flow table if an entry for the flow is found in the flow table; and
forwarding the packet to an upstream network device configured to forward the packet if an entry for the flow is not found in the flow table.

2. The method of claim 1 wherein processing the packet comprises forwarding the packet to a downstream node.

3. The method of claim 2 wherein forwarding the packet to the downstream node comprises forwarding the packet only if a permit flag is set in said entry in the flow table.

4. The method of claim 1 wherein processing the packet comprises dropping the packet if a deny flag is set in said entry in the flow table.

5. The method of claim 1 wherein said entry comprises a key corresponding to one or more fields in the packet.

6. The method of claim 1 wherein said entry comprises a destination interface and wherein processing the packet comprises forwarding the packet to said destination interface.

7. The method of claim 1 wherein said entry comprises a flag indicating if the packet is to be forwarded or dropped by the fabric extender.

8. The method of claim 1 further comprising receiving a probe packet at the fabric extender and updating the flow table based on information in said probe packet.

9. The method of claim 1 further comprising forwarding one out of a specified number of packets to the upstream network device if an entry associated with the packet is found in the flow table, receiving the forwarded packet from the upstream network device, and updating the flow table to synchronize the fabric extender with the upstream network device.

10. An apparatus comprising
a plurality of interfaces for communication with one or more upstream network devices configured for forwarding packets, and communication with one or more downstream nodes;
a processor for performing a look up in a flow table at a fabric extender for a flow associated with a packet received at one of said interfaces in communication with the downstream node, processing the packet based on an entry in the flow table if an entry for the flow is found in the flow table, and forwarding the packet to the upstream network device if an entry for the flow is not found in the flow table; and
memory for storing the flow table.

11. The apparatus of claim 10 wherein processing the packet comprises forwarding the packet to the downstream node.

12. The apparatus of claim 11 wherein forwarding the packet to the downstream node comprises forwarding the packet only if a permit flag is set in said entry in the flow table.

13. The apparatus of claim 10 wherein processing the packet comprises dropping the packet if a deny flag is set in said entry in the flow table.

14. The apparatus of claim 10 wherein said entry comprises a key corresponding to one or more fields in the packet.

15. The apparatus of claim 10 wherein said entry comprises a destination interface and wherein processing the packet comprises forwarding the packet to said destination interface.

16. The apparatus of claim 10 wherein said entry comprises a flag indicating if the packet is to be forwarded or dropped by the apparatus.

17. The apparatus of claim 10 wherein the processor is further configured for processing a probe packet received at the fabric extender and updating the flow table based on information in said probe packet.

18. The apparatus of claim 10 wherein the processor is further configured for forwarding one out of a specified number of packets to the upstream network device if an entry associated with the packet is found in the flow table, receiving the forwarded packet from the upstream network device, and updating the flow table to synchronize the fabric extender with the upstream network device.

19. An apparatus comprising:
means for performing a look up in a flow table at a fabric extender for a flow associated with a received packet;
means for processing the packet at the fabric extender based on an entry in the flow table if an entry for the flow is found in the flow table; and
means for forwarding the packet to an upstream network device configured to forward the packet if an entry for the flow is not found in the flow table.

20. The apparatus of claim 19 wherein means for processing the packet comprises means for forwarding the packet to a downstream node.
